(19) United States
(12) Patent Application Publication
(10) Pub. No.: US 2025/0050953 A1
(43) Pub. Date: Feb. 13, 2025

(54) LOWER SIDE STRUCTURE OF A VEHICLE

(71) Applicants: HYUNDAI MOTOR COMPANY, Seoul (KR); KIA CORPORATION, Seoul (KR)

(72) Inventor: Sung-Won Kim, Hwaseong-si (KR)

(73) Assignees: HYUNDAI MOTOR COMPANY, Seoul (KR); KIA CORPORATION, Seoul (KR)

(21) Appl. No.: 18/529,037

(22) Filed: Dec. 5, 2023

(30) Foreign Application Priority Data
Aug. 11, 2023 (KR) 10-2023-0105607

(51) Int. Cl. B62D 25/20; B60K 1/04; B60N 2/005; B62D 21/03; B62D 25/02; B62D 27/02

(52) U.S. Cl. CPC B62D 25/2036; B60K 1/04; B60N 2/005; B62D 21/03; B62D 25/025; B62D 27/02; B60K 2001/0438; B62D 21/157

(57) ABSTRACT

A lower side structure of a vehicle includes a side sill outer having a convex cross-section shape that is convexly curved toward an outside of the vehicle, a center floor main panel which has both side ends bonded to an upper end of the side sill outer and forms a floor of a vehicle, and a lower member having both ends bonded to a lower end portion of the side sill outer and assembled to a lower portion of the center floor main panel. In particular, a closed cross-section is formed between the side sill outer, the center floor main panel, and the lower member.

### CROSS-REFERENCE(S) TO RELATED APPLICATIONS

This application claims priority to Korean Patent Application No. 10-2023-0105607, filed on Aug. 11, 2023, which is incorporated herein by reference in its entirety.

### FIELD

Embodiments of the present disclosure relate to a body structure of a vehicle.

### BACKGROUND

The statements in this section merely provide background information related to the present disclosure and may not constitute prior art.

A vehicle is provided with a side sill formed in a lengthwise direction of the vehicle to form a lower side structure of the vehicle. The side sill is a structural component typically located beneath a door along the bottom edge of the vehicle's body.

In the side sill, side sill inners disposed in an interior of the vehicle are coupled to both end portions of a center floor panel forming a floor of the interior of the vehicle.

In electric vehicles, a battery is usually disposed below the center floor panel. The battery is mounted by fastening battery mounting bolts to pass through the side sill inners. Alternatively, the battery is mounted by installing a separate mount inside the side sill inner and by fastening the battery mounting bolt to the mount.

When a vehicle is involved in a side collision and there is no structure to support a collision load transmitted from a side surface of the vehicle, the side sill is deformed due to an impact and invades into a passenger compartment of the vehicle. Such deformation of the side sill induces injury to occupants and causes damage to the battery.

In addition, since moisture may be introduced through a bonding surface between the side sill inner and the center floor panel, a separate sealing process is required to prevent the moisture from being introduced therebetween.

### SUMMARY

Embodiments of the present disclosure are directed to a lower side structure of a vehicle, which supports a collision load transmitted from a side surface of the vehicle in the event of a side collision and prevent deformation of the lower side structure toward an inside of the vehicle.

Other objects and advantages of the present disclosure can be understood by the following description and become apparent with reference to the embodiments of the present disclosure. Also, it is obvious to those of having ordinary skill in the art to which the present disclosure pertains that the objects and advantages of the present disclosure can be realized by the means as claimed and combinations thereof.

In accordance with an embodiment of the present disclosure, a lower side structure of a vehicle includes: a side sill outer having a convex cross-sectional shape that is convexly curved toward an outside of the vehicle, and a center floor main panel having both side end portions bonded to an upper end portion of the side sill outer. The center floor main panel forms a floor of the vehicle.

In one embodiment, the lower side structure may further include a lower member having both end portions bonded to a lower end portion of the side sill outer and assembled to a lower portion of the center floor main panel. The side sill outer, the center floor main panel, and the lower member may form a closed cross-section.

In one embodiment, the lower side structure may further include: between the side sill outer, the center floor main panel, and the lower member, a side sill outer bulkhead supported on an inner surface of the side sill outer; and a side sill inner bulkhead which is positioned inside the vehicle than the side sill outer bulkhead. The side sill inner bulkhead is in contact with the side sill outer bulkhead and supported on inner surfaces of the center floor main panel and the lower member.

A surface where the side sill outer bulkhead and the side sill inner bulkhead may be in contact each other may be formed to have a step portion.

The surface where the side sill outer bulkhead and the side sill inner bulkhead may be in contact with each other may be bent toward the outside of the vehicle at an upper portion of the surface.

In another embodiment, the lower side structure may further include a side sill outer reinforcement pipe installed to pass through the side sill outer bulkhead, and a side sill inner reinforcement pipe installed to pass through the side sill inner bulkhead and inserted at a predetermined length from an end portion of the side sill outer reinforcement pipe.

The side sill outer reinforcement pipe and the side sill inner reinforcement pipe may be disposed above a step portion of the surface where the side sill outer bulkhead and the side sill inner bulkhead are in contact with each other.

In another embodiment, a seat cross member disposed in a width direction of the vehicle may be assembled on an upper surface of the center floor main panel, and the seat cross member may be disposed in a portion where the side sill inner bulkhead is installed in a lengthwise direction of the vehicle.

In one embodiment, the center floor main panel may include an upper bonding portion bonded to an upper end portion of the side sill outer, an upper reinforcement portion formed from the upper bonding portion to be spaced apart from the side sill outer, and a center floor panel portion extending from the upper reinforcement portion toward an inside of the vehicle.

In one embodiment, the upper reinforcement portion may include a horizontal portion extending from a lower end portion of the upper bonding portion in a horizontal direction to be spaced apart from the side sill outer, and a vertical portion extending downward from the horizontal portion.

In one embodiment, the lower member may include a lower bonding portion bonded to the lower end portion of the side sill outer, a lower reinforcement portion connected to the lower bonding portion and forming a closed cross-section with the side sill outer, a panel bonding portion bonded to a bottom surface of the center floor main panel, and a battery mounting portion on which a battery is mounted.

In one embodiment, the lower reinforcement portion may include a horizontal portion extending from an upper end portion of the lower bonding portion in a horizontal direction to be spaced apart from the side sill outer, and a vertical portion formed to extend upward from the horizontal portion.

The panel bonding portion may be formed to have an open bottom, and the battery mounting portion may be formed to have an open top.

A support may be provided inside the panel bonding portion.

The support may be disposed in a portion in which a side sill outer bulkhead supported on an inner surface of the side sill outer and a side sill inner bulkhead supported on inner surfaces of the center floor main panel and the lower member are installed.

A battery mount to which a battery fastening bolt is fastened may be assembled to the battery mounting portion.

Further areas of applicability will become apparent from the description provided herein. It should be understood that the description and specific embodiments are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is an external perspective view partially illustrating a lower side structure of a vehicle according to an embodiment of the present disclosure;

FIG. 2 is an enlarged cut-away perspective view illustrating a main part of the lower side structure of a vehicle according to an embodiment of the present disclosure;

FIG. 3 is an internal perspective view illustrating the lower side structure of a vehicle according to an embodiment of the present disclosure;

FIG. 4 is an exploded perspective view illustrating the lower side structure of a vehicle according to an embodiment of the present disclosure;

FIG. 5 is a perspective view illustrating a state in which a center floor main panel is removed from the lower side structure of a vehicle according to an embodiment of the present disclosure;

FIG. 6 is a schematic cross-sectional view illustrating the lower side structure of a vehicle according to an embodiment of the present disclosure; and

FIG. 7 is a schematic diagram illustrating an assembly process of the lower side structure of a vehicle according to the present disclosure.

The drawings described herein are for illustration purposes only and are not intended to limit the scope of the present disclosure in any way.

### DESCRIPTION OF SPECIFIC EMBODIMENTS

The following description is merely exemplary in nature and is not intended to limit the present disclosure, application, or uses. It should be understood that throughout the drawings, corresponding reference numerals indicate like or corresponding parts and features.

When a component, device, element, or the like of the present disclosure is described as having a purpose or performing an operation, function, or the like, the component, device, or element should be considered herein as being “configured to” meet that purpose or to perform that operation or function.

Hereinafter, a lower side structure of a vehicle according to the present disclosure is described in detail with reference to the accompanying drawings.

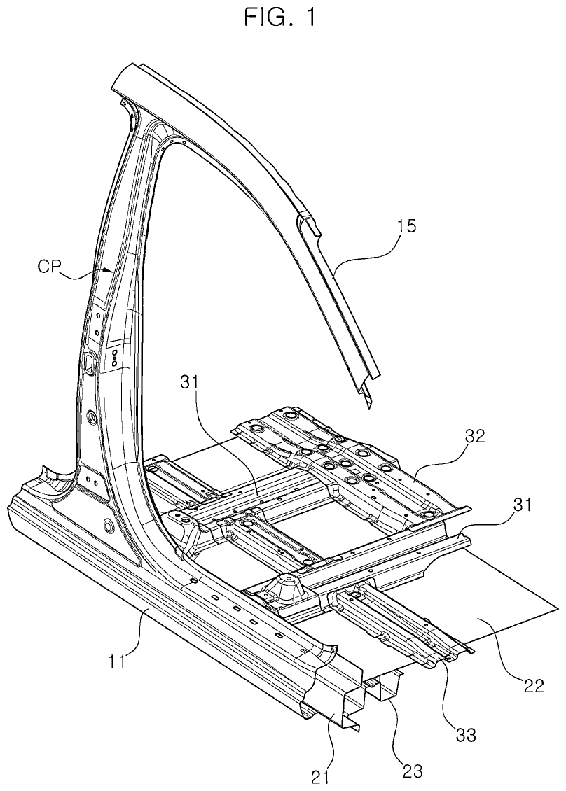

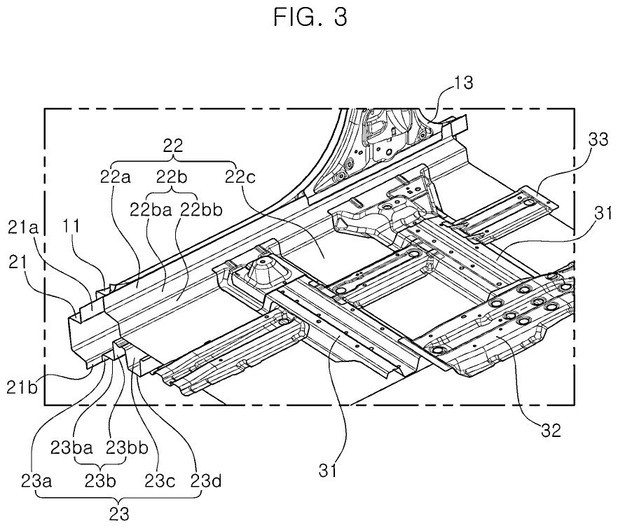

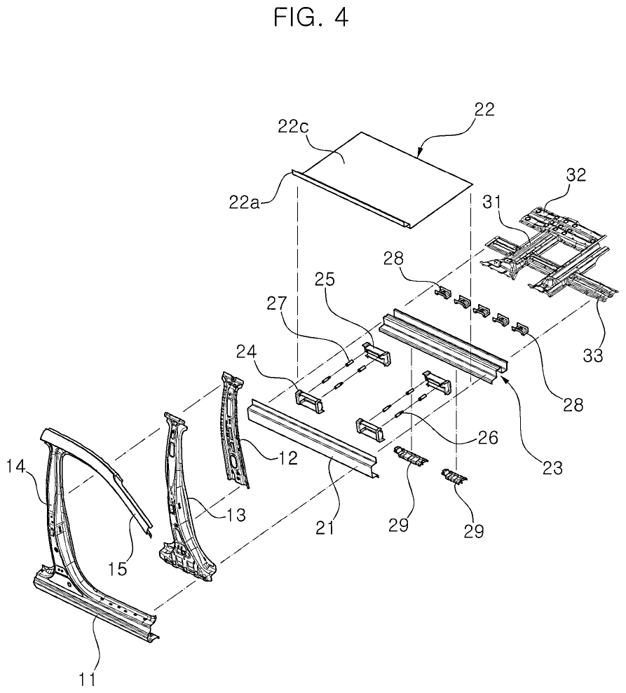

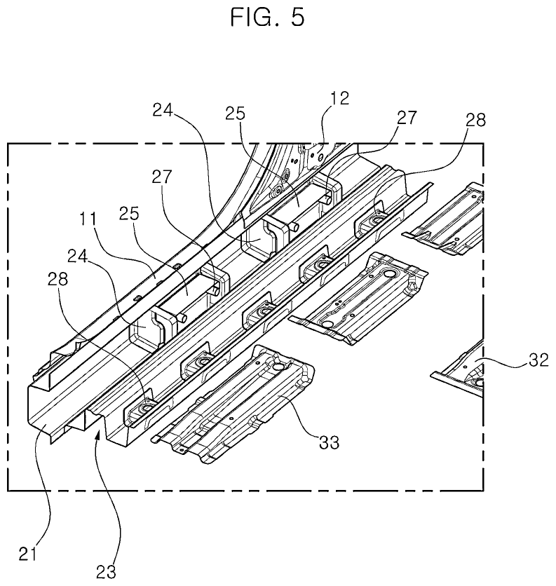

According to an embodiment of the present disclosure, referring to FIGS. 1-7, the lower side structure of a vehicle may include: side sill outers 21 having a convex cross-sectional shape that is convexly curved toward an outside of the vehicle, and a center floor main panel 22 having both side end portions bonded to upper end portions 21a of the side sill outers 21. The center floor main panel 22 forms a floor of the vehicle. The lower side structure further includes a lower member 23 having both side end portions bonded to lower end portions 21b of the side sill outers 21 and assembled to a lower portion of the center floor main panel 22, and the side sill outer 21, the center floor main panel 22, and the lower member 23 form a closed cross-section.

A side sill outer panel 11 may be assembled on an outside of the side sill outer 21 of the vehicle.

The side sill outer panel 11 may be directly or indirectly connected to a center pillar outer 12, a center pillar inner 13, and a center pillar outer panel 14 which are positioned above the side sill outer panel 11 and constitute a center pillar CP.

A roof side rail 15 may be provided to be connected to an upper end portion of the center pillar CP.

As illustrated in FIG. 1, the side sill outer 21 may have a convex cross-sectional shape that is convexly curved toward the outside of the vehicle. The upper end portion 21a and lower end portion 21b of the side sill outer 21 may be bonded to the center floor main panel 22 and the lower member 23, respectively, and a space may be formed therein.

The both side end portions of the center floor main panel 22 may be bonded to the upper end portions 21a of the side sill outers 21, and the center floor main panel 22 may form a floor of the vehicle, thereby serving as an upper portion of the side sill inner and the center floor panel in the conventional vehicle structure.

The center floor main panel 22 may be formed in a symmetrical structure in a width direction of the vehicle, and the both side end portions of the center floor main panel 22 are bonded to the upper end portions 21a of the side sill outers 21.

Since the center floor main panel 22 is integrally formed to serve as a conventional side sill inner and a conventional center floor panel, no separate sealing work may be required on an upper surface of the center floor main panel 22.

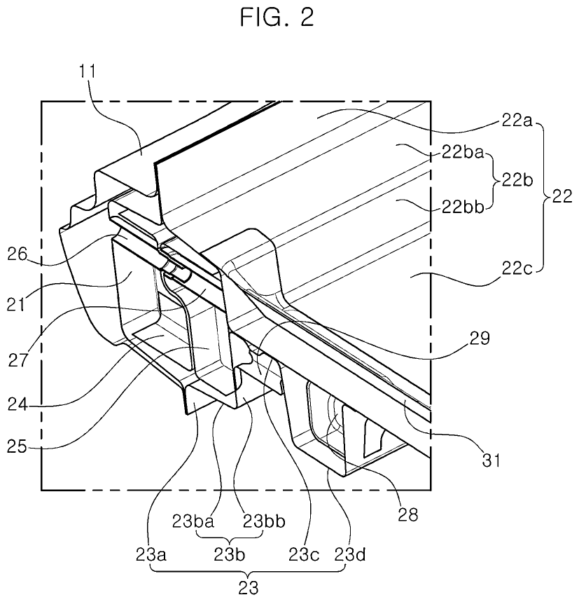

Describing a shape of the center floor main panel 22 in detail, as shown in FIG. 2, the center floor main panel 22 may include an upper bonding portion 22a bonded to the upper end portion 21a of the side sill outer 21, an upper reinforcement portion 22b formed from the upper bonding portion 22a to be spaced apart from the side sill outer 21, and a center floor panel portion 22c extending from the upper reinforcement portion 22b to the inside of the vehicle.

The upper bonding portion 22a may be formed at an end portion of the center floor main panel 22. The upper bonding portion 22a may be bent to face upward in parallel to the upper end portion 21a of the side sill outer 21 that is bent upward. The upper bonding portion 22a may be bonded to the bent upper end portion 21a of the side sill outer 21. The center floor main panel 22 may be bonded to the side sill outer 21 through the bonding structure of the upper end portion 21a and the upper bonding portion 22a.

The upper reinforcement portion 22b may be formed to extend from the upper bonding portion 22a. The upper reinforcement portion 22b may be formed to allow the center floor main panel 22 to be spaced apart from the side sill outer 21. In addition, the upper reinforcement portion 22b may serve as an upper portion of the conventional side sill inner. To this end, the upper reinforcement portion 22b may include a horizontal portion 22ba extending from a lower end portion of the upper bonding portion 22a in a horizontal direction to be spaced apart from the side sill outer 21, and a vertical portion 22bb vertically extending downward from the horizontal portion 22ba. The horizontal portion 22ba and the vertical portion 22bb may form a cross section bent from the center floor main panel 22, thereby providing rigidity.

The center floor panel portion 22c may extend from a lower end portion of the vertical portion 22bb toward the inside of the vehicle. The center floor panel portion 22c may form the floor of the vehicle.

In order to mount a seat on the center floor panel portion 22c, a seat cross member 31 may be disposed in the width direction of the vehicle.

In addition, a first sub-member 32 and a second sub-member 33 may be disposed to intersect the seat cross member 31 in the center floor panel portion 22c in the lengthwise direction of the vehicle. Since the seat cross member 31 is disposed to be perpendicular to the first sub-member 32 and the second sub-member 33 on the upper surface of the center floor main panel 22, rigidity of the center floor panel portion 22c, which is formed in a plane, may be improved.

The both side end portions of the lower members 23 may be bonded to lower end portions 21b of the side sill outers 21, and the lower members 23 may be assembled to the lower portion of the center floor main panel 22. The lower member 23 may be formed with a predetermined length from the side sill outer 21 in the width direction of the vehicle. The lower member 23 may serve as a lower portion of the conventional side sill inner and may serve to connect the side sill outer 21 to the center floor main panel 22. In addition, in the case of the electric vehicle, a battery BAT of the vehicle may be mounted on the lower member 23.

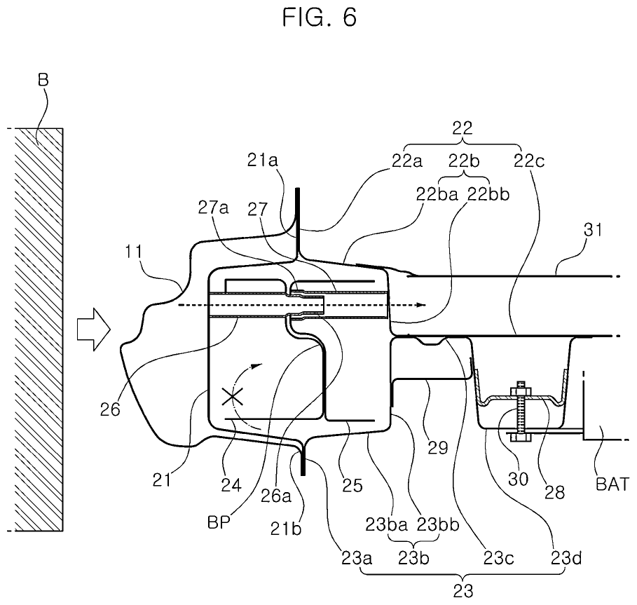

Describing a shape of the lower member 23 in detail, as shown in FIG. 6, the lower member 23 may include a lower bonding portion 23a bonded to the lower end portion 21b of the side sill outer 21, a lower reinforcement portion 23b connected to the lower bonding portion 23a and coupled to the side sill outer 21 to form a closed cross-section, a panel bonding portion 23c bonded to a bottom surface of the center floor main panel 22, and a battery mounting portion 23d on which the battery BAT is mounted.

The lower bonding portion 23a may be formed at a side end portion of the lower member 23. The lower bonding portion 23a may be formed to extend downward of the vehicle. The lower bonding portion 23a may extend downward in parallel to the lower end portion 21b of the side sill outer 21 and may be bonded to the lower end portion 21b of the side sill outer 21. The lower member 23 may be bonded to the side sill outer 21 through the lower bonding portion 23a.

The lower reinforcement portion 23b may be formed to extend from the lower bonding portion 23a. The lower reinforcement portion 23b may be formed to allow the lower member 23 to be spaced apart from the side sill outer 21. In addition, the upper reinforcement portion 22b may serve as a lower portion of the conventional side sill inner. To this end, the lower reinforcement portion 23b may include a horizontal portion 23ba extending from an upper end portion of the lower bonding portion 23a in the horizontal direction to be spaced apart from the side sill outer 21, and a vertical portion 23bb vertically extending upward from the horizontal portion 23ba. Like the upper bonding portion 22a, the lower bonding portion 23a, the horizontal portion 23ba, and the vertical portion 23bb may form a cross section bent from the lower member 23, thereby providing rigidity.

The panel bonding portion 23c may be formed to have an open bottom, and the battery mounting portion 23d may be formed to have an open top. The panel bonding portion 23c may be assembled to the center floor panel portion 22c of the center floor main panel 22, and thus the lower member 23 may be integrated with the center floor main panel 22. In order to improve rigidity of the panel bonding portion 23c, a groove (to which a reference numeral is not given) may be formed on an upper surface of the panel bonding portion 23c in the lengthwise direction of the vehicle. In a state in which the panel bonding portion 23c is bonded to a bottom surface of the center floor panel portion 22c, the upper surface of the panel bonding portion 23c may be assembled to the center floor panel portion 22c.

In contrast to the panel bonding portion 23c, the battery mounting portion 23d may be formed to have an open top. Battery mounts 28 may be assembled to the battery mounting portion 23d. The battery mount 28 may be assembled to the battery mounting portion 23d in a state in which a circumference of the battery mount 28 is in surface contact with the battery mounting portion 23d. The battery mounts 28 may be assembled to the battery mounting portion 23d at intervals in the lengthwise direction of the vehicle. The battery fastening bolt 30 may pass through the battery mounting portion 23d to be fastened to the battery mount 28 so that the battery may be mounted in a lower portion of the vehicle.

An end portion of the battery mounting portion 23d, i.e., an inner end portion of the lower member 23, may be also assembled to the bottom surface of the center floor panel portion 22c.

A closed cross-section may be formed between the side sill outer 21, the center floor main panel 22, and the lower member 23 in the lengthwise direction of the vehicle to form a side sill so that the lower side structure of a vehicle is formed. In particular, the upper bonding portion 22a of the center floor main panel 22 and the lower bonding portion 23a of the lower member 23 may serve as the upper portion and the lower portion of the conventional side sill inner and are assembled to the side sill outer 21 so that a side sill structure is formed.

Meanwhile, in the present disclosure, a structure, which is capable of supporting a collision load in the event of a side collision of the vehicle, may be additionally applied between the side sill outer 21, the center floor main panel 22, and the lower member 23.

In an embodiment of the present disclosure, a side sill outer bulkhead 24 and a side sill inner bulkhead 25 may be applied between the side sill outer 21, the center floor main panel 22, and the lower member 23.

The side sill outer bulkhead 24 and the side sill inner bulkhead 25 may support an interior of the closed cross-section space formed by the side sill outer 21, the center floor main panel 22, and the lower member 23 in the width direction of the vehicle. In other words, in the event of a side collision, the side sill outer 21, the center floor main panel 22, and the lower member 23 may primarily support a collision load, and the side sill outer bulkhead 24 and the side sill inner bulkhead 25 may additionally support the collision load in the closed cross-sectional space.

Both end portions of the side sill outer bulkhead 24 may be supported in contact with an inner surface of the side sill outer 21 in the lengthwise direction of the vehicle. An inner surface of the side sill outer bulkhead 24 in the width direction may be in contact with the side sill inner bulkhead 25.

The side sill inner bulkhead 25 may be positioned inside the vehicle than the side sill outer bulkhead 24, may be in contact with the side sill outer bulkhead 24, and may be supported on inner surfaces of the center floor main panel 22 and the lower member 23. One side surface of the side sill inner bulkhead 25, e.g., an outer side in the width direction, may be in contact with the side sill outer bulkhead 24. Both end portions of the side sill inner bulkhead 25 may be supported on the inner surfaces of the center floor main panel 22 and the lower member 23 in the lengthwise direction of the vehicle.

Thus, in the event of a side collision, a collision load input to the side sill outer 21 may be transmitted to the center floor main panel 22 and the lower member 23 through the side sill outer bulkhead 24 and the side sill inner bulkhead 25.

Meanwhile, the side sill outer bulkhead 24 and the side sill inner bulkhead 25 are joined in a stepwise manner with each other. In other words, a surface where the side sill outer bulkhead 24 and the side sill inner bulkhead 25 are in contact with each other may be formed to be bent to form a bent portion BP. The bent portion BP is bent toward the outside of the vehicle, and the bent portion BP is located at an upper portion of the surface. According to the above-described structure, an upper portion of the side sill inner bulkhead 25 may firmly support an upper portion of the side sill outer bulkhead 24. Therefore, in the event of the side collision, the side sill outer bulkhead 24 and the side sill inner bulkhead 25 may prevent the side sill from invading the inside of the vehicle.

In particular, the seat cross member 31 may be disposed in a portion where the side sill inner bulkhead 25 is installed in the lengthwise direction of the vehicle to allow the seat cross member 31 to support the collision load input to the side sill outer bulkhead 24 and the side sill inner bulkhead 25.

In addition, a support 29 may be provided inside the panel bonding portion 23c in the lower member 23. The support 29 may be inserted into the panel bonding portion 23c having the open bottom and may prevent the panel bonding portion 23c from being deformed in the width direction of the vehicle. The support 29 may be also provided in a portion where the side sill outer bulkhead 24 and the side sill inner bulkhead 25 are installed.

In addition, a side sill outer reinforcement pipe 26 and a side sill inner reinforcement pipe 27 may be additionally provided inside the side sill outer bulkhead 24 and the side sill inner bulkhead 25.

The side sill outer reinforcement pipe 26 may be installed to pass through the side sill outer bulkhead 24, and the side sill inner reinforcement pipe 27 may be installed to pass through the side sill inner bulkhead 25.

The side sill outer reinforcement pipe 26 and the side sill inner reinforcement pipe 27 may be disposed above the portion where the step portion is formed on the surface where the side sill outer bulkhead 24 and the side sill inner bulkhead 25 are in contact with each other.

In this case, a front end portion of the side sill outer reinforcement pipe 26 may pass through the side sill outer bulkhead 24 and the side sill inner bulkhead 25 to be inserted into the side sill inner reinforcement pipe 27 at a predetermined length. In one embodiment, an insertion portion 26a may be formed in the side sill outer reinforcement pipe 26, an accommodation portion 27a into which the insertion portion 26a is inserted may be formed in the side sill inner reinforcement pipe 27, and the insertion portion 26a may be inserted into the accommodation portion 27a so that the side sill outer reinforcement pipe 26 is inserted into the side sill inner reinforcement pipe 27.

Because the side sill outer reinforcement pipe 26 is partially inserted into the side sill inner reinforcement pipe 27, in the event of a side collision, a part of a collision load may further insert the side sill outer reinforcement pipe 26 into the interior of the side sill inner reinforcement pipe 27 so that the part of the collision load may be exhausted.

Because the members supporting the side collision are concentrated and disposed in a portion where the seat cross member 31 is mounted, the load input due to the side collision may be supported so that the side sill may be rotated and deformed and may be prevented from intruding into the interior of the vehicle.

The side sill outer bulkhead 24 and the side sill inner bulkhead 25 may be disposed inside the closed cross-section formed by the side sill outer 21, the center floor main panel 22, and the lower member 23 in the portion where the seat cross member 31 is mounted, and the side sill outer reinforcement pipe 26 and the side sill inner reinforcement pipe 27 may be inserted into the side sill outer bulkhead 24 and the side sill inner bulkhead 25, respectively.

In addition, the support 29 on the lower member 23 may be also installed at the portion where the seat cross member 31 is mounted in the lengthwise direction of the vehicle.

FIG. 6 shows a state in which a barrier “B” collides with a side surface of the vehicle by assuming a side collision. When the barrier B first hits the side sill outer panel 11, a collision load may be transmitted to the side sill outer panel 21. The collision load may be transmitted to the inside of the vehicle through a path such as an arrow shown as dotted line in FIG. 6.

In this case, the collision load may be transmitted from the side sill outer panel 11 to the inside of the vehicle through the side sill outer 21. Since the side sill outer bulkhead 24 and the side sill inner bulkhead 25 support the collision load in the closed cross-section space formed by the side sill outer 21, the center floor main panel 22, and the lower member 23 in the width direction of the vehicle, the side sill outer 21 may prevent rotational deformation in a direction of the arrow toward the inside of the vehicle. In addition, since the side sill outer bulkhead 24 and the side sill inner bulkhead 25 are formed to be stepped, and the side sill outer reinforcement pipe 26 and the side sill inner reinforcement pipe 27 are inserted above the side sill outer bulkhead 24 and the side sill inner bulkhead 25, the collision load may be supported while the rotational deformation of the side sill outer 21 may be prevented.

Thereafter, the collision load may be supported by the support 29 and may be also supported by the seat cross member 31. The seat cross member 31 may be disposed in alignment with the side sill outer bulkhead 24, the side sill inner bulkhead 25, the side sill outer reinforcement pipe 26, the side sill inner reinforcement pipe 27, and the support 29 in the width direction of the vehicle. Thus, the collision load input during the side collision may be supported, and thus a phenomenon in which the side sill outer 21 may be rotationally deformed to intrude into a passenger compartment may be prevented so that an injury to a passenger may be reduced.

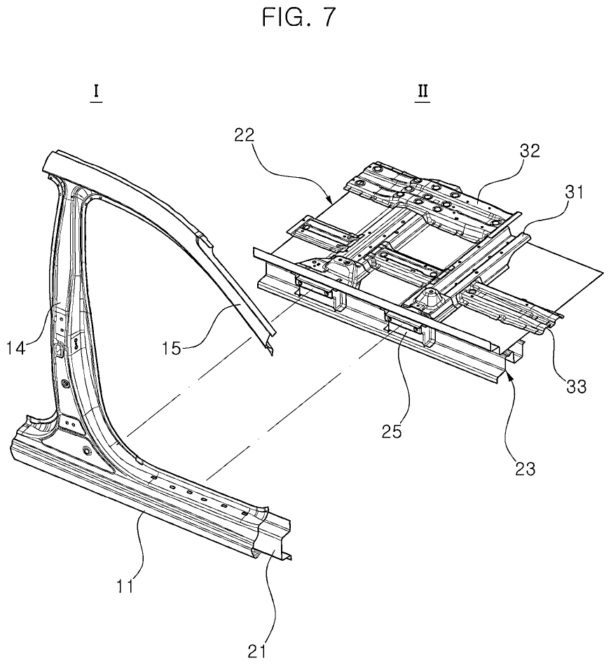

FIG. 7 shows a process of assembling the lower side structure of a vehicle according to the present disclosure.

First, a side assembly I and a floor assembly II each may be assembled, respectively.

The side assembly I is in a state in which the side sill outer panel 11, the center pillar outer 12, the center pillar inner 13, the center pillar outer panel 14, the roof side rail 15, the side sill outer 21, the side sill outer bulkhead 24, and the side sill outer reinforcement pipe 26 may be assembled.

The floor assembly II is in a state in which the center floor main panel 22, the lower member 23, the seat cross member 31, the first sub-member 32, the second sub-member 33, the side sill inner bulkhead 25, and the side sill inner reinforcement pipe 27 may be assembled.

The side assembly I and the floor assembly II may be disposed at correct positions.

When the side assembly I and the floor assembly II are disposed at the correct positions, the upper end portion 21a of the side sill outer 21 and the upper bonding portion 22a of the center floor main panel 22 may be assembled using welding and, simultaneously, the lower end portion 21b of the side sill outer 21 and the lower bonding portion 23a of the lower member 23 of the center floor main panel 22 may be assembled to form the structure as shown in FIG. 1.

In accordance with the lower side structure of a vehicle according to the present disclosure, which has the above-described configuration, since a side sill inner and a center floor panel are integrally formed, a structure may be simplified and foreign materials such as moisture may be prevented from being introduced between the side sill inner and the center floor panel.

In addition, since the side sill outer bulkhead and the side sill inner bulkhead are installed to be in contact with each other, a collision load input during a side collision may be supported.

In addition, the collision load may be exhausted when the side sill outer reinforcement pipe and the side sill inner reinforcement pipe may be fitted into each other. Thus, a phenomenon in which the collision load deforms a side sill to invade into an interior of a passenger compartment may be prevented.

Since the side sill may not invade into the passenger compartment during the side collision, an injury to a passenger may be reduced and damage to a battery may be prevented.

While the embodiments of the present disclosure have been described, those of having ordinary skill in the art should understand that the present disclosure can be implemented in other specific forms without departing from the technical spirit or the necessary features of the present disclosure. Therefore, it should be understood that the above-described embodiments are not restrictive but illustrative in all aspects.

What is claimed is:

1. A lower side structure of a vehicle, the lower side structure comprising:
a side sill outer having a convex cross-sectional shape, convexly curved toward an outside of the vehicle; and
a center floor main panel including side end portions and configured to form a floor of the vehicle, wherein the side end portions of the center floor main panel are bonded to an upper end portion of the side sill outer.

2. The lower side structure of claim 1, further comprising:
a lower member including end portions bonded to a lower end portion of the side sill outer and assembled to a lower portion of the center floor main panel,
wherein the side sill outer, the center floor main panel, and the lower member are configured to form a closed cross-section.

3. The lower side structure of claim 2, further comprising: between the side sill outer, the center floor main panel, and the lower member,
a side sill outer bulkhead supported on an inner surface of the side sill outer; and
a side sill inner bulkhead, which is positioned inside the vehicle than the side sill outer bulkhead, is in contact with the side sill outer bulkhead, wherein the side sill inner bulkhead is supported on inner surfaces of the center floor main panel and the lower member.

4. The lower side structure of claim 3, wherein a surface where the side sill outer bulkhead and the side sill inner bulkhead are in contact each other is formed to have a step portion.

5. The lower side structure of claim 4, wherein the surface where the side sill outer bulkhead and the side sill inner bulkhead are in contact with each other is bent toward the outside of the vehicle at an upper portion thereof.

6. The lower side structure of claim 3, further comprising:
a side sill outer reinforcement pipe installed to pass through the side sill outer bulkhead; and
a side sill inner reinforcement pipe installed to pass through the side sill inner bulkhead and inserted at a predetermined length from an end portion of the side sill outer reinforcement pipe.

7. The lower side structure of claim 6, wherein the side sill outer reinforcement pipe and the side sill inner reinforcement pipe are disposed above a step portion of a surface where the side sill outer bulkhead and the side sill inner bulkhead are in contact with each other.

8. The lower side structure of claim 3, wherein:
a seat cross member disposed in a width direction of the vehicle is assembled on an upper surface of the center floor main panel; and
the seat cross member is disposed in a portion where the side sill inner bulkhead is installed in a lengthwise direction of the vehicle.

9. The lower side structure of claim 1, wherein the center floor main panel includes:
an upper bonding portion bonded to an upper end portion of the side sill outer;
an upper reinforcement portion formed from the upper bonding portion to be spaced apart from the side sill outer; and
a center floor panel portion extending from the upper reinforcement portion toward an inside of the vehicle.

10. The lower side structure of claim 9, wherein the upper reinforcement portion includes:
a horizontal portion extending from a lower end portion of the upper bonding portion in a horizontal direction to be spaced apart from the side sill outer; and
a vertical portion extending downward from the horizontal portion.

11. The lower side structure of claim 2, wherein the lower member includes:
a lower bonding portion bonded to the lower end portion of the side sill outer;
a lower reinforcement portion connected to the lower bonding portion and forming a closed cross-section with the side sill outer;
a panel bonding portion bonded to a bottom surface of the center floor main panel; and
a battery mounting portion on which a battery is mounted.

12. The lower side structure of claim 11, wherein the lower reinforcement portion includes:
a horizontal portion extending from an upper end portion of the lower bonding portion in a horizontal direction to be spaced apart from the side sill outer; and
a vertical portion formed to extend upward from the horizontal portion.

13. The lower side structure of claim 11, wherein:
the panel bonding portion is formed to have an open bottom; and
the battery mounting portion is formed to have an open top.

14. The lower side structure of claim 11, wherein a support is provided inside the panel bonding portion.

15. The lower side structure of claim 14, wherein the support is disposed in a portion in which a side sill outer bulkhead supported on an inner surface of the side sill outer and a side sill inner bulkhead supported on inner surfaces of the center floor main panel and the lower member are installed.

16. The lower side structure of claim 12, wherein a battery mount to which a battery fastening bolt is fastened is assembled to the battery mounting portion.

17. A lower side structure of a vehicle, the lower side structure comprising:
a side sill outer formed with a cross-section that is convexly curved toward an outside of the vehicle;
a center floor main panel forming a floor of the vehicle and including side end portions bonded to an upper end portion of the side sill outer; and
a lower member including end portions bonded to a lower end portion of the side sill outer and assembled to a lower portion of the center floor main panel,
wherein the lower member includes:
a lower bonding portion bonded to the lower end portion of the side sill outer;
a lower reinforcement portion connected to the lower bonding portion and forming a closed cross-section with the side sill outer;
a panel bonding portion bonded to a bottom surface of the center floor main panel; and
a battery mounting portion on which a battery is mounted.

18. The lower side structure of claim 17, further comprising:
a side sill outer bulkhead supported on an inner surface of the side sill outer; and
a side sill inner bulkhead being in contact with the side sill outer bulkhead and supported on inner surfaces of the center floor main panel and the lower member.

19. The lower side structure of claim 18, further comprising:
a side sill outer reinforcement pipe installed to pass through the side sill outer bulkhead; and
a side sill inner reinforcement pipe installed to pass through the side sill inner bulkhead and fitted into each other.

20. The lower side structure of claim 18, wherein a surface where the side sill outer bulkhead and the side sill inner bulkhead are in contact with each other is formed to be bent.
